(19) United States
(12) Patent Application Publication
(10) Pub. No.: US 2009/0058836 A1
(43) Pub. Date: Mar. 5, 2009

(54) VIDEO DATA REVISION METHOD FOR ELECTRON EMISSION DISPLAY DEVICE

(76) Inventors: Mun-seok Kang, Suwon (KR); Chul-ho Lee, Suwon (KR); Young-jun Yun, Suwon (KR)

Correspondence Address: CHRISTIE, PARKER & HALE, LLP, PO BOX 7068, PASADENA, CA, 91109-7068, US

(21) Appl. No.: 12/137,601

(22) Filed: Jun. 12, 2008

(30) Foreign Application Priority Data
Aug. 28, 2007 (KR) 10-2007-0086508

(51) Int. Cl. G09G 5/00; G09G 3/20

(52) U.S. Cl. 345/204; 345/74.1

(57) ABSTRACT

An apparatus and method for revising video data for en electron emission display device to improve image quality by reducing non-uniformity in luminance of a plurality of pixels. In an exemplary embodiment, a display region includes a plurality of pixels, each pixel comprising at least one electron emission device. A scan driver and a data driver control the pixels through electrodes coupled to the display region. A revision coefficient unit is coupled to the display driver, for storing a plurality of revision coefficients, receiving and revising video data utilizing the revision coefficients, and sending revised video data to the data driver. The revision coefficients correspond to first average luminance values of first lines of pixels extending in a first direction, and second average luminance values of second lines of pixels extending in a second direction.

### CROSS-REFERENCE TO RELATED APPLICATION

This application claims priority to and the benefit of Korean Patent Application No. 10-2007-0086508, filed on Aug. 28, 2007, in the Korean Intellectual Property Office, the entire content of which is incorporated herein by reference.

### BACKGROUND

1. Field of the Invention

The present invention relates to a video data revision method for an electron emission display device, and more specifically to a video data revision method for an electron emission display device for preventing non-uniformity in luminance by compensating for luminance difference between respective pixels due to non-uniformity in an electron emission unit and a phosphor layer, etc.

2. Description of Related Art

Slim and lightweight flat panel display devices have been used as monitors for mobile communication devices such as personal computers, mobile phones, PDAs, etc. Some examples of flat panel display devices include liquid crystal displays (LCDs), organic light emitting diode (OLED) based displays, plasma display panels (PDPs), and electron emission display devices, among others.

Flat panel display devices can be divided into active matrix devices and passive matrix devices in view of the structure of the display driver, and whether it uses a memory-based driving mode or a non-memory-based driving mode in view of a light emitting principle. It can be said that active matrix driving devices have a memory-based driving mode and passive matrix devices have a non-memory-based driving mode. That is, active matrix devices, having a memory-based driving mode emit light during essentially a whole image frame, and passive matrix devices, having a non-memory-based driving mode emit light essentially only during a period of a line unit.

FIG. 1 is a schematic diagram showing an electron emission display device. Referring to FIG. 1, the electron emission display device includes a display region 10, a data driver 20, and a scan driver 30.

The display region 10 includes pixels 11 formed where cathode electrodes C1, C2, . . . Cn cross gate electrodes G1, G2, . . . Gn. The pixels 11 in the illustrated device include electron emission units, wherein electrons emitted from the cathode electrodes impinge on high-voltage anode electrodes to emit light from phosphors in corresponding light emission units, thereby displaying video images. The gray levels of the displayed video images vary depending on the values of inputted digital video data. In order to control the gray levels represented depending on the values of the digital image signals, a pulse width modulation method may be used. The pulse width modulation method is a method that controls the amount of time when data signals with an essentially constant voltage are applied to the cathode electrodes. That is, if the applied time is long, high gray levels are represented and if the applied time is short, low gray levels are represented.

The data driver 20 generates data signals using video data. The data driver 20 is coupled to the cathode electrodes C1, C2 . . . Cn to transfer the data signals to the display region 10 so that the display region 10 emits light corresponding to the data signals.

The scan driver 30 generates scan signals and transfers them to the display region 10 through the gate electrodes G1, G2, . . . Gn so that the display region 10 utilizes a line scan method. In other words, the scan driver 30 sequentially light emits the pixels 11 for a substantially constant time in a horizontal line unit of the display region 10 to display the entire screen, making it possible to drive it while reducing circuit costs and power consumption.

In the electron emission display device described above, electron emission units are positioned at each of the plurality of pixels 11 and the electrons are emitted from the electron emission units so that the amount of emitted electrons determines the luminance of the pixels. However, in a manufacturing process of electron emission units, differences in the amount of emitted electrons occur due to non-uniformity in the characteristics of the electron emission units even when the same video data are input, leading to a problem that the luminance of each pixel may be different.

### SUMMARY

Embodiments of the present invention provide an apparatus and method for revising video data for an electron emission display device to improve image quality by revising non-uniformity in luminance of a plurality of pixels.

An electron emission display device according to a first exemplary embodiment of the present invention includes a display region including a plurality of pixels, each pixel comprising at least one electron emission device. A scan driver is coupled to the plurality of pixels through a plurality of first electrodes extending in a first direction, the scan driver for driving scan signals to the first portion of the plurality of pixels through the first electrodes. A data driver is coupled to the plurality of pixels through a plurality of second electrodes extending in a second direction, the data driver for driving data signals to the plurality of pixels through the second electrodes. A revision coefficient unit is coupled to the data driver for storing a plurality of revision coefficients, receiving and revising video data utilizing the revision coefficients, and sending revised video data to the data driver. The revision coefficients correspond to first average luminance values of first lines of pixels extending in the first direction, and second average luminance values of second lines of pixels extending in the second direction.

A method of revising video data and generating data signals for a plurality of pixels according to a second exemplary embodiment of the present invention includes measuring luminance of each of the plurality of pixels to generate luminance data; calculating first average luminance values per line in a plurality of horizontal lines and calculating second average luminance values per line in a plurality of vertical lines; and computing a revision coefficient for one pixel among the plurality of pixels corresponding to the first average luminance values and the second average luminance values by utilizing the horizontal line and the vertical line that includes the one pixel among the plurality of pixels.

### BRIEF DESCRIPTION OF THE DRAWINGS

These and/or other embodiments and features of the invention will become apparent and more readily appreciated from the following description of certain exemplary embodiments, taken in conjunction with the accompanying drawings of which:

FIG. 1 is a structural view showing an electron emission display device;

FIG. 2 is a structural view showing an electron emission display device according to a first embodiment of the present invention;

FIG. 3 is a view showing a method of computing revision coefficients for revising video data according to an embodiment of the present invention;

FIG. 4 is a structural view showing an electron emission display device according to a second embodiment of the present invention;

FIG. 5A is a graph showing variations in luminance average values of odd numbered lines; and

FIG. 5B is a graph showing variations in luminance average values of even numbered lines.

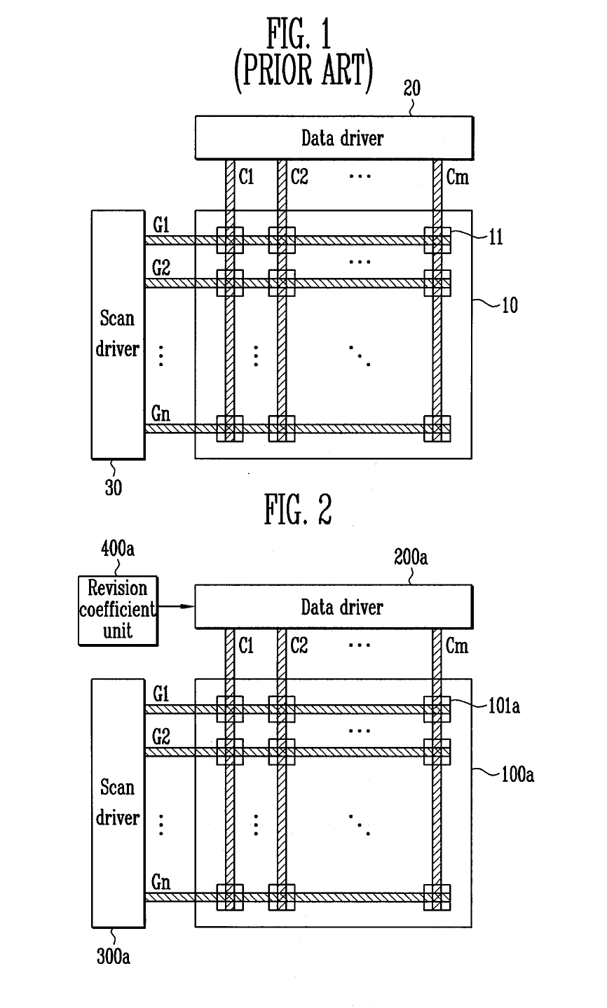

### DETAILED DESCRIPTION OF EXEMPLARY EMBODIMENTS

Hereinafter, certain exemplary embodiments according to the present invention will be described with reference to the accompanying drawings. Here, when a first element is described as being coupled to a second embodiment, the first element may be directly coupled to the second element or may alternatively be indirectly coupled to the second element via a third element. Further, some elements that may not be essential to the complete understanding of the prevention have been omitted for clarity. Also, like reference numerals refer to like elements throughout.

Hereinafter, embodiments according to the present invention will be described with reference to the accompanying drawings.

FIG. 2 is a schematic diagram of an electron emission display device according to a first embodiment of the present invention. Referring to FIG. 2, the electron emission display device includes a display region 100a, a data driver 200a, a scan driver 300a, and a revision coefficient unit 400a.

The display region 100a includes pixels 101a formed where cathode electrodes C1, C2, . . . Cn cross gate electrodes G1, G2, . . . Gn. The pixels 101a include electron emission units, wherein electrons emitted from the cathode electrodes impinge on high-voltage anode electrodes to emit light from phosphors in the corresponding light emission units, thereby displaying video images. The gray levels of the displayed videos vary depending on the values of inputted digital video data. In order to control the gray levels represented depending on the values of the digital image signals, a pulse width modulation method may be used. The pulse width modulation method is a method that controls the amount of time when data signals with a substantially constant voltage are applied to the cathode electrodes. That is, if the applied time is long, high gray levels are represented and if the applied time is short, low gray levels are represented.

The data driver 200a generates data signals using video data. The data driver 200a is coupled to the cathode electrodes C1, C2 . . . Cn to transfer the data signals to the display region 100a so that the display region 100a emits light corresponding to the data signals.

The scan driver 300a generates scan signals and transfers them to the display region 100a through the gate electrodes G1, G2, . . . Gn so that the display region 100a is driven utilizing a line scan method. In other words, the scan driver 300a sequentially emits light from the pixels 101a for a substantially constant time in a horizontal line unit of the display region 100a to display the entire screen, making it possible to drive it while reducing circuit costs and power consumption.

The revision coefficient unit 400a stores revision coefficients for the pixels 101a, revises the video data transferred to each of the pixels 101a using the revision coefficients, and then transfers the revised video data to the data driver 200a. The revision coefficients are computed corresponding to luminance deviations in the pixels 101a. When the respective pixels 101a receive the same video data after being revised by the revision coefficients, they can emit light at the same luminance. Therefore, the non-uniformity between the respective pixels can be reduced or prevented by utilizing the revision coefficients.

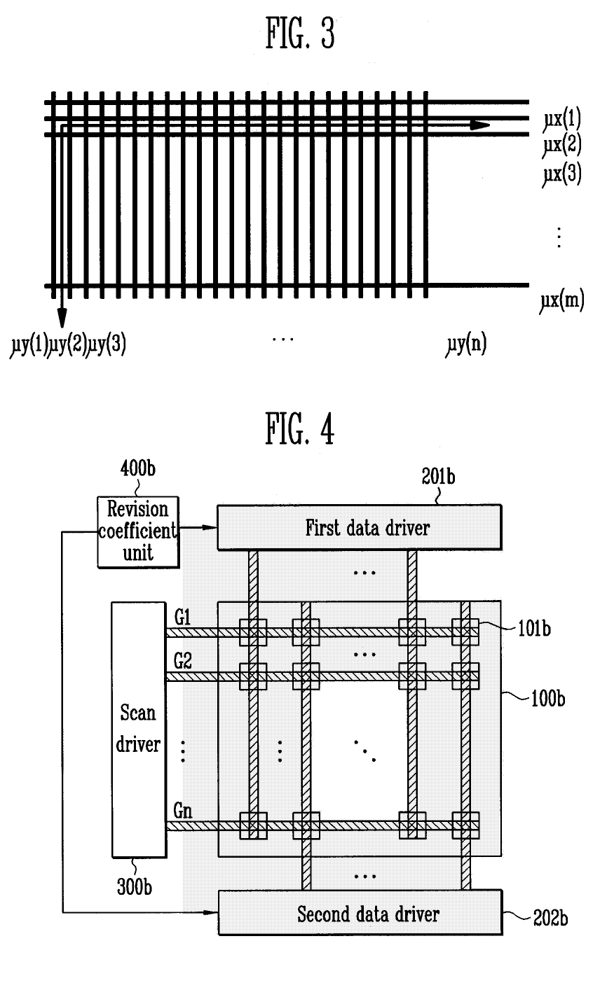

FIG. 3 is a schematic diagram showing a method of computing revision coefficients for revising or adjusting video data according to an exemplary embodiment of the present invention. In FIG. 3, it is assumed that the display region has m×n resolution.

Referring to FIG. 3, the same data signals are first transferred to each of m×n pixels, and the luminance in each pixel is measured. At this time, the transferred data signal has gray level values to cause the pixels to represent maximum luminance. Average luminance values μx(1), μx(2), . . . μx(m-1), μx(m) in the respective horizontal lines (or rows) of the display region and average luminance values μy(1), μy(2), μy(n-1), μy(n) in the respective vertical lines (or columns) thereof are measured.

An exemplary method of computing a revision coefficient, for example, the revision coefficient of any pixel, that is, the pixel positioned at the m^{th} horizontal line and n^{th} vertical line, will now be described. A threshold value (OffsetRatio) corresponding to any one of red, blue, and green sub-pixels is multiplied by an average of the m^{th} row average luminance value μx(m) and the n^{th} column average luminance value μy(n) (i.e., Mean(μx(m), μy(n))). In alternative embodiments, other functions of μx(m) and μy(n) may be used, such as the minimum (Min(μx(m), μy(n))), the maximum (Max(μx(m), μy(n))), or some other function, and one skilled in the art will understand that the invention is not limited to any particular embodiment. The product is divided by the actually represented luminance measured from light emitted by the pixel positioned at the crossing of the m^{th} row and n^{th} column (i.e., L(m,n)). Because the respective sub-pixels of red, blue, and green have different luminous efficiency, when the same ratio is applied thereto, there is a risk of upsetting the white balance. This is because a difference in luminance reduction before and after the compensation for each color of red, green, and blue occurs. Therefore, predefined threshold values (OffsetRatio) corresponding to red, blue, and green are used according to which of the red, blue, or green color is represented by the pixel that requires the threshold value to maintain white balance.

The video data and the revision coefficients may be operated by converting the luminance average values to have digital values such as the video data. That is, in one embodiment, a normalization factor (NormFactor) is multiplied with the above ratio. The normalization factor may be 2^{b}, where (b) represents the number of bits in the digital video data. Therefore, the revision coefficient may be represented by the following equation 1.

$$Coeff ( m , n ) = \frac{Mean ( μ x ( m ) , μ y ( n ) ) \times OffsetRatio}{L ( m , n )} \times NormFactor \qquad Equation 1$$

where L(m, n) is the actual luminance of the pixel positioned at the m^{th} horizontal line (row) and n^{th} vertical line (column); Mean(μx(m), μy(n)) is an average value of the m^{th} row average luminance value μx(m) and the n^{th} column average luminance value μy(n); OffsetRatio is a threshold value corresponding to respective ones of red, blue, and green; and NormFactor is a number for converting revision coefficients to digital values.

The revision coefficients generated by Equation 1 are stored in the revision coefficient unit 400b and are applied to the video data, making it possible to revise the video data.

FIG. 4 is a block diagram showing an electron emission display device according to a second exemplary embodiment of the present invention. Referring to FIG. 4, the electron emission display device includes a display region 100b, a first data driver 201b, a second data driver 202b, a scan driver 300b, and a revision coefficient unit 400b.

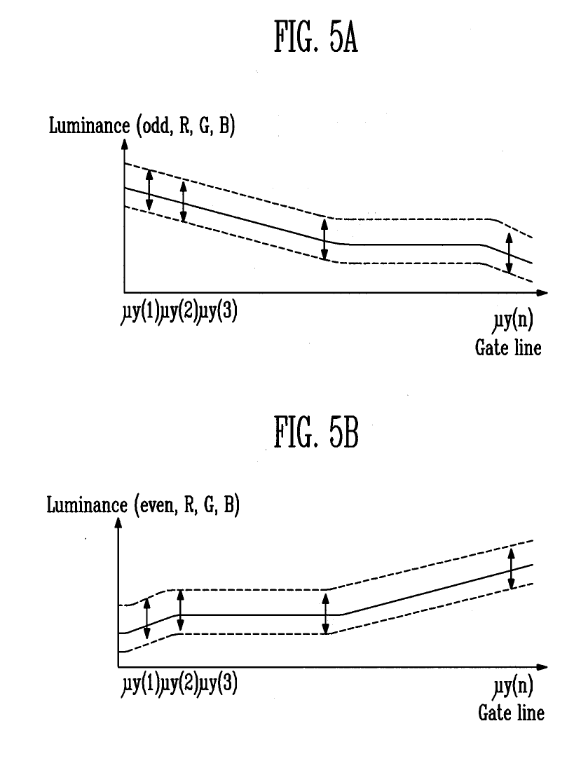

In an exemplary embodiment of the electron emission display device as described above, including the first and second data drivers 201b and 202b, the first data driver 201b is positioned at the upper end of the display region 100b and coupled to odd numbered data lines and the second data driver 202b is positioned at the lower end of the display region 100b and coupled to even numbered data lines. The data signals transferred from the first data driver 201b are transferred from the upper end of the display region 100b to the lower end thereof and the data signals transferred from the second data driver 202b are transferred from the lower end of the display region 100b to the upper end thereof. At this time, in the cases where, by electrical influence of the display region 100b, for example, inner resistance and/or capacitance, the data signals are transferred from the upper end of the display region 100b to the lower end thereof and from the lower end of the display region 100b to the upper end thereof, the difference in luminance as shown in FIGS. 5a and 5b may occur.

Referring to FIGS. 5A and 5B, the luminance average values of the pixels are lowered as they go from the upper end to the lower end in the odd numbered data lines, and the luminance average values of the pixels are increased as they go from the upper end to the lower end in the even numbered data lines.

Therefore, first revision coefficients corresponding to the odd numbered lines and second revision coefficients corresponding to the even numbered lines are stored in the revision coefficient unit 400b so that when generating the revision coefficients, the first revision coefficients are applied to pixels 101b corresponding to the odd numbered lines and the second revision coefficients are applied to the pixels 101b corresponding to the even numbered lines. As a result, the difference in luminance between the odd numbered lines and the even numbered lines of the pixels 100b can be compensated.

With the electron emission display device and the video data revision method thereof according to an exemplary embodiment of the present invention, the revision coefficients are computed by the average values of the vertical lines and the horizontal lines so that even when there is much difference in the luminance characteristics of the upper, lower, left, and right of the electron emission display device, the image quality can be improved.

And, the white balance prior to the compensation can be kept and the computation of the revision coefficients may be different according to a waveform applying method so that the non-uniformity in luminance between the pixels due to the electrical load characteristics of the display region can be prevented.

Although exemplary embodiments of the present invention have been shown and described, it would be appreciated by those skilled in the art that changes might be made in these embodiments without departing from the principles and spirit of the invention, the scope of which is defined in the claims and their equivalents.

What is claimed is:

1. An electron emission display device comprising:
a display region comprising a plurality of pixels, each pixel comprising at least one electron emission device;
a scan driver coupled to the plurality of pixels through a plurality of first electrodes extending in a first direction, the scan driver for driving scan signals to the plurality of pixels through the first electrodes; and
a data driver coupled to the plurality of pixels through a plurality of second electrodes extending in a second direction, the data driver for driving data signals to the plurality of pixels through the second electrodes;
a revision coefficient unit coupled to the data driver for storing a plurality of revision coefficients, receiving and revising video data utilizing the revision coefficients, and sending revised video data to the data driver,
wherein the revision coefficients correspond to first average luminance values of lines of pixels extending in the first direction and second average luminance values of lines of pixels extending in the second direction.

2. The electron emission display device as claimed in claim 1, wherein one of the revision coefficients that corresponds to a pixel among the plurality of pixels is calculated in part by averaging the first average luminance value of a line of pixels extending in the first direction including the pixel and the second average luminance value of a line of pixels extending in the second direction including the pixel.

3. The electron emission display device as claimed in claim 1, wherein one of the revision coefficients that corresponds to a pixel among the plurality of pixels is calculated in part by multiplying an average of the first average luminance value of a line of pixels extending in the first direction including the pixel and the second average luminance value of a line of pixels extending in the second direction including the pixel, by threshold values corresponding to colors representing sub-pixels of the pixel.

4. The electron emission display device as claimed in claim 1, wherein in the data driver, a transfer direction of the data signals transferred to odd numbered electrodes of the plurality of second electrodes is opposite to a transfer direction of the data signals transferred to even numbered electrodes of the plurality of second electrodes.

5. The electron emission display device as claimed in claim 4, wherein the second average luminance values comprise first revision coefficients corresponding to the odd numbered second electrodes and second revision coefficients corresponding to the even numbered second electrodes.

6. The electron emission display device as claimed in claim 4, wherein the data signals are transferred to vertical lines.

7. A method of revising video data and generating data signals for a plurality of pixels, the method comprising:
measuring luminance of each of the plurality of pixels;
calculating first average luminance values per line in a plurality of horizontal lines and calculating second luminance average values per line in a plurality of vertical lines; and
computing a revision coefficient for one pixel among the plurality of pixels corresponding to the first average luminance values and the second average luminance values by utilizing the horizontal line and the vertical line that includes the one pixel among the plurality of pixels.

8. The method as claimed in claim 7, wherein said computing the revision coefficient comprises averaging the first average luminance values and the second average luminance values and then multiplying them by threshold values corresponding to colors representing sub-pixels of the one pixel.

9. The method as claimed in claim 7, wherein in measuring the luminance, each pixel receives a reference data signal and the luminance resulting from the reference data signal is measured.

10. The method as claimed in claim 7, wherein the data signals are transferred to the vertical lines.

11. The method as claimed in claim 7, wherein in computing the revision coefficients, separate threshold values per the pixels of red, green, and blue are set and the separate threshold values are multiplied by average values of the first average luminance values and the second average luminance values.

12. The method as claimed in claim 7, wherein the data signals for odd numbered lines of the vertical lines are transferred in a direction opposite to the direction that data signals for even numbered lines are transferred.

13. The method as claimed in claim 12, wherein first revision coefficients are utilized in the average luminance values of the odd numbered lines and second revision coefficients are utilized in the average luminance values of the even numbered lines.
